(19) United States
(12) Patent Application Publication
(10) Pub. No.: US 2023/0313483 A1
(43) Pub. Date: Oct. 5, 2023

(54) METHODS AND ASSEMBLIES FOR ELECTRICALLY GROUNDING AND CORROSION-PROTECTING A METALLIC STRUCTURE

(71) Applicant: SHORE ACRES ENTERPRISES INC., BARRIE (CA)

(72) Inventors: BRIEN TODD SIROLA, BARRIE (CA); CHRISTOPHER PAUL BERNI, BARRIE (CA); DONALD BRIEN SIROLA, BARRIE (CA); CAITLIN EMMA MORRISSEY HUGHES, COLLINGWOOD (CA); MICHAEL STANLEY ARNEW, AURORA (CA)

(73) Assignee: SHORE ACRES ENTERPRISES INC., BARRIE (CA)

(21) Appl. No.: 18/331,984

(22) Filed: Jun. 9, 2023

Related U.S. Application Data
(63) Continuation-in-part of application No. 17/868,950, filed on Jul. 20, 2022.
Application No. 17/868,950 is a continuation of application No. 16/837,284, filed on Apr. 1, 2020, now Pat. No. 11,421,392.
(60) Provisional application No. 62/949,489, filed on Dec. 18, 2019.

(51) Int. Cl. E02D 5/80; H02G 9/02

(52) U.S. Cl. CPC E02D 5/80; H02G 9/025; E02D 2300/002

(57) ABSTRACT

An electrically grounded and corrosion-protected assembly includes a utility pole having a bottom portion that is buried in the earth. A water impermeable and electrically conductive cementitious surround is applied to at least a section of the portion that is buried in the earth. The surround is in direct contact with the section and is between the section and the earth. A brace is embedded in the surround and supports the utility pole. The brace may include an aggregate such as gravel.

### CROSS REFERENCES TO RELATED APPLICATIONS

This application is a continuation in part of U.S. patent application Ser. No. 17/868,950 filed on Jul. 20, 2022, which is a continuation of U.S. patent application Ser. No. 16/837,284 filed on Apr. 1, 2020 (now U.S. Pat. No. 11,421,392), which claims the benefit of U.S. Provisional Patent Application No. 62/949,489, filed on Dec. 18, 2019, all of which are incorporated herein by reference in their entirety.

### TECHNICAL FIELD

This document relates to metallic structures, such as metallic poles (e.g. utility poles) and/or anchor rods for guy wires. More specifically, this document relates to the electrical grounding of such structures, the protection of buried portions of such structures from corrosion, and the support of such structures.

### BACKGROUND

U.S. Pat. No. 10,262,773 (Sirola et al.) discloses a method for protecting a conductive metal from corrosion, including coating the conductive metal with a water impermeable carbonaceous conductive material to protect the conductive metal from corrosion.

### SUMMARY

This summary is intended to introduce the reader to the subject matter of the detailed description, and is not intended to define or delimit any invention.

Electrically grounded and corrosion-protected assemblies are disclosed.

According to some aspects, an electrically grounded and corrosion-protected assembly includes a metallic structure. At least a portion of the metallic structure is buried in the earth. A water impermeable and electrically conductive cementitious surround is applied to at least a section of the portion that is buried in the earth. The surround is in direct contact with the section and is between the section and the earth.

In some examples, the surround has a top edge, and the assembly further includes a diverter positioned on the top edge and extending around the metallic structure. The diverter is shaped to direct water away from the metallic structure.

In some examples, the metallic structure is a pole. In some examples, the metallic structure is an anchor rod. In some examples, the metallic structure is a cladding on a non-metallic structure.

In some examples, the cementitious surround includes a cementitious matrix and a particulate carbonaceous material dispersed in the cementitious matrix. The cementitious matrix can include Portland cement. The particulate carbonaceous material can include calcined petroleum coke. The cementitious surround can include between 5 wt % and 70 wt % Portland cement, and between 30 wt % and 90 wt % calcined petroleum coke. The cementitious surround can include up to 50% slag.

In some examples, the surround has a compressive strength of at least 50 psi.

In some examples, the assembly further includes an electrically conductive and water impermeable jacket encasing the surround. The jacket can include a polymeric matrix, and a particulate carbonaceous material dispersed in the polymeric matrix.

In some examples, the assembly further includes an electrically conductive and water impermeable brace embedded in the surround and supporting the metallic structure. The brace can include a polymeric matrix, and a particulate carbonaceous material dispersed in the polymeric matrix.

In some examples, the surround holds the metallic structure in a generally vertical position.

According to some aspects, an electrically grounded and corrosion-protected assembly includes a metallic structure having a bottom portion that is buried in the earth. A water impermeable and electrically conductive cementitious surround is applied to at least a section of the portion that is buried in the earth. The surround is in direct contact with the section and is between the section and the earth. A brace is embedded in the surround and supports the metallic structure.

In some examples, the metallic structure is a utility pole. The utility pole can include a metallic body and an electrically conductive and water impermeable jacket applied to the metallic body.

In some examples, the brace is non electrically conductive and non water impermeable.

In some examples, the brace includes an aggregate. In some examples, the brace includes a gravel.

In some examples, the cementitious surround includes a cementitious matrix and a particulate carbonaceous material dispersed in the cementitious matrix. The cementitious matrix may include Portland cement. The particulate carbonaceous material may include calcined petroleum coke. The cementitious surround may include between 5 wt % and 70 wt % Portland cement, and between 30 wt % and 90 wt % calcined petroleum coke. The cementitious surround may include up to 50% slag.

Methods for electrically grounding and corrosion-protecting a metallic structure are also disclosed.

According to some aspects, a method for electrically grounding and corrosion-protecting a metallic structure includes a) applying a cementitious product to at least a section of a metallic structure, wherein the cementitious product includes a cementitious matrix and a particulate carbonaceous material dispersed in the matrix; and b) curing the cementitious product to form a water impermeable and electrically conductive cementitious surround on the section.

In some examples, the method further includes, prior to step a), digging a hole in the earth for the metallic structure, wherein the hole is sized to leave a gap between the metallic structure and the earth, and lowering at least a bottom portion of the metallic structure into the hole. The section can be a section of the bottom portion.

In some examples, the cementitious product is a cementitious slurry. The method can further include combining a cementitious powder with water to form the cementitious slurry. The cementitious powder can be combined with the water in a ratio of less than or equal to 3 US gallons of water per 55 lb of cementitious powder. The cementitious powder can be combined with the water in a ratio of between about 1.5 and about 3.0 US gallons of water per 55 lb of cementitious powder. The method can further include applying the cementitious slurry to the hole before lowering at least the bottom portion of the metallic structure into the hole. Lowering the bottom portion of the metallic structure into the hole can force the slurry to fill the gap or the bottom portion of the pole.

In some examples, the cementitious product is a cementitious powder, and the method further includes adding water to the cementitious powder.

In some examples, the method further includes, prior to step a), applying a jacket to the section. The jacket can be sized to leave a gap around the section.

In some examples, the metallic structure is a pole or an anchor rod for a guy wire or a cladding on a non-metallic pole.

In some examples, the surround has a width of between about 0.5 inch and about 10 inches.

In some examples, the method further includes applying a diverter around a top edge of the surround, to direct water away from the metallic structure.

In some examples, the cementitious matrix includes Portland cement. In some examples, the particulate carbonaceous material includes calcined petroleum coke.

In some examples, the cementitious surround includes between 5 wt % and 70 wt % Portland cement, and between 30 wt % and 90 wt % calcined petroleum coke. The cementitious surround can include up to 50% slag.

In some examples, the method further includes bracing the metallic structure with at least one brace. The brace can be electrically conductive and water impermeable. Bracing the metallic structure can include embedding the brace in the surround.

According to some aspects, a method for electrically grounding and corrosion-protecting a metallic structure includes: a) combining a cementitious powder with water to form a cementitious slurry, wherein the cementitious powder comprises a cement and a particulate carbonaceous material, and wherein the cementitious powder is combined with the water in a ratio of less than or equal to about 2.5 US gallons of water per 55 lb of cementitious powder; b) applying the cementitious slurry to at least a section of the metallic structure; and c) curing the cementitious slurry to form a water impermeable and electrically conductive cementitious surround on the section.

In some examples, the ratio is between about 2.5 US gallons of water and 1.5 US gallons of water per 55 lb of cementitious powder. In some examples, the ratio is about 2.5 US gallons of water per 55 lb of cementitious powder. In some examples, the ratio is about 2.0 US gallons of water per 55 lb of cementitious powder. In some examples, the ratio is about 1.8 US gallons of water per 55 lb of cementitious powder.

In some examples, the surround has a compressive strength of greater than or equal to about 50 psi. In some examples, the surround has a compressive strength of greater than or equal to about 2000 psi after 28 days of curing.

In some examples, the method further includes, prior to step a): digging a hole in the earth for the metallic structure, wherein the hole is sized to leave a gap between the metallic structure and the earth; and lowering at least a bottom portion of the metallic structure into the hole. The method may further include pouring the cementitious slurry in to the gap, to apply the cementitious slurry to the bottom portion of the metallic structure.

In some examples, the cement includes Portland cement. In some examples, the particulate carbonaceous material includes calcined petroleum coke. In some examples, the cementitious powder includes between about 20 wt % and about 80 wt % Portland cement, and between about 30 wt % and about 80 wt % calcined petroleum coke.

Methods for electrically grounding and corrosion-protecting a metallic structure are further disclosed.

According to some aspects, a method for electrically grounding and corrosion-protecting a metallic structure includes: a. positioning a brace in a gap around a bottom portion of a metallic structure that has been lowered into a hole in the earth, wherein the gap is between the bottom portion and the earth, and wherein the brace is positioned around the metallic structure to support the metallic structure; b. enveloping the brace in a cementitious slurry, wherein the cementitious slurry comprises a cementitious matrix and a particulate carbonaceous material dispersed in the matrix; and c. curing the cementitious slurry with the brace embedded therein, to form a water impermeable and electrically conductive cementitious surround on the section.

In some examples, step a. includes at least partially filling the gap with an aggregate, to form the brace. The aggregate may include a gravel. Step a. may further include compacting the gravel.

In some examples, the method further includes combining a cementitious powder with water to form the cementitious slurry. The cementitious powder may be combined with the water in a ratio of less than or equal to about 5 US gallons of water per 55 lb of cementitious powder. The cementitious powder may be combined with the water in a ratio of between about 3.0 and about 4.0 US gallons of water per 55 lb of cementitious powder.

In some examples, the cementitious powder includes between 5 wt % and 70 wt % Portland cement, and between 30 wt % and 90 wt % calcined petroleum coke.

In some examples, there is a delay of at least one day between steps a. and b.

In some examples, the method further includes adjusting the metallic structure between steps a. and b.

Intermediate assemblies, which are curable to yield an electrically grounded and corrosion-protected assembly, are further disclosed.

According to some aspects, an intermediate assembly that is curable to yield an electrically grounded and corrosion-protected assembly includes: a metallic structure, wherein at least a portion of the metallic structure is buried in the earth; and a cementitious slurry applied to at least a section of the portion that is buried in the earth, wherein the cementitious slurry includes a cementitious product and water, wherein the cementitious product includes a cement and a particulate carbonaceous material, and wherein the cementitious slurry includes less than or equal to about 2.5 US gallons of water per 55 lb of cementitious product.

In some examples, the cementitious slurry includes between about 2.5 US gallons of water and 1.5 US gallons of water per 55 lb of cementitious product. In some examples, the cementitious slurry includes about 2.5 US gallons of water per 55 lb of cementitious product. In some examples, the cementitious slurry includes about 2.0 US gallons of water per 55 lb of cementitious product.

In some examples, the metallic structure is a pole.

In some examples, the cement includes Portland cement. In some examples, the particulate carbonaceous material includes calcined petroleum coke. In some examples, the cementitious product includes between about 20 wt % and about 80 wt % Portland cement, and between about 30 wt % and about 80 wt % calcined petroleum coke.

Cementitious slurries are further disclosed.

According to some aspects, a cementitious slurry, which curable to form a water impermeable and electrically conductive cementitious surround on a metallic structure, includes a cementitious product including between about 5 wt % and about 70 wt % Portland cement, and between about 30 wt % and about 90 wt % calcined petroleum coke; and water; wherein the cementitious slurry comprises less than or equal to about 2.5 US gallons of water per 55 lb of cementitious product.

Assemblies for supporting a metallic structure, protecting the metallic structure from corrosion, and electrically grounding the metallic structure are further disclosed.

According to some aspects, an assembly for supporting a metallic structure, protecting the metallic structure from corrosion, and electrically grounding the metallic structure includes a water impermeable and electrically conductive cementitious surround including a cementitious matrix and a particulate carbonaceous material dispersed in the cementitious matrix. The surround provides corrosion protection and electrical grounding. A brace is embedded in the surround. The brace provides support.

In some examples, the brace includes an aggregate.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a partial and schematic cross-sectional view showing a cementitious slurry being applied to a bottom portion of a utility pole; and

FIG. 2 is a partial and schematic cross-sectional view showing a utility pole with a cementitious surround applied thereto;

FIG. 3 is a partial and schematic cross-sectional view showing an anchor rod with a cementitious surround applied thereto;

FIG. 4 is a perspective view of an example jacket usable with the cementitious surrounds described herein;

FIG. 5 is a partial and schematic cross-sectional view showing the jacket of FIG. 4 applied to the anchor rod and cementitious surround of FIG. 3;

FIG. 6 is a perspective view of an example brace usable with the cementitious surrounds described herein;

FIG. 7 is a partial and schematic cross-sectional view showing the brace of FIG. 6 applied to the utility pole and cementitious surround of FIG. 2;

FIG. 8 is a partial and schematic cross-sectional view showing another example brace applied to the utility pole, with a cementitious slurry being applied to the brace and the utility pole; and

FIG. 9 shows the experimental setup of Example 2.

### DETAILED DESCRIPTION

Various apparatuses or processes or compositions will be described below to provide an example of an embodiment of the claimed subject matter. No embodiment described below limits any claim and any claim may cover processes or apparatuses or compositions that differ from those described below. The claims are not limited to apparatuses or processes or compositions having all of the features of any one apparatus or process or composition described below or to features common to multiple or all of the apparatuses or processes or compositions described below. It is possible that an apparatus or process or composition described below is not an embodiment of any exclusive right granted by issuance of this patent application. Any subject matter described below and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

Disclosed herein is a cementitious product that, when in its cured state, forms a water impermeable and electrically conductive surround for buried portions (e.g. bottom portions) of metallic structures, or for sections of such buried portions. Such structures can include those used in the electrical power distribution and transmission industry, or in the telecommunications industry, or in the street lighting industry, or in various other industries. For example, metallic structures can include poles (e.g. steel poles) such as utility poles or telecommunications poles or street lighting poles. For further example, metallic structures can include anchor rods for guy wires. For further example, metallic structures can include metallic parts of ancillary structures (e.g. metal claddings on non-metallic structures such as concrete poles or composite poles or wood poles). For further example, metallic structures can include fence posts (e.g. galvanized steel fence posts), or towers. The cementitious product can be used to facilitate installation of the metallic or ancillary structure (i.e. can set and support a metallic utility pole or metal-clad non-metallic utility pole, to hold the utility pole in a generally vertical position), provide electrical grounding to the metallic or ancillary structure, and protect the buried portion of the metallic structure (or the section thereof) from corrosion.

The cementitious product can be applied to the metallic structure in situ. For example, the cementitious product can be applied in situ as a retrofit to a metallic structure that has already been installed and used, or can be applied in situ upon installation of a new metallic structure. For example, in the case of a new installation, the bottom portion of a metallic utility pole can be placed in a hole that has been dug in the earth (e.g. into a hole dug for the utility pole using an auger). A brace, for example an aggregate brace as described in further detail below, can be used to support the utility pole. The cementitious product, in slurry form or in powder form, can be poured around the bottom portion of the utility pole so that it is in direct contact with the utility pole, and so that the brace is embedded in the cementitious product. The cementitious product can cure in-situ around the bottom portion of the utility pole (e.g. the slurry can cure in-situ, or the powder can absorb environmental water (e.g. rain water) and then cure in-situ) and with the brace embedded therein, so that the cementitious product is between the utility pole and the earth and can form a barrier between the utility pole and the earth, with the brace fixed in place by the cementitious product. When cured, the cementitious product can form a surround (also referred to herein as a “cementitious surround”) around the bottom portion of the utility pole that (1) anchors the utility pole in the earth (i.e. holds up or, together with the brace, helps to hold up or supports or sets the utility pole in a generally vertical position, so that a separate backfill material is not necessarily required); (2) is water impermeable to protect the bottom portion of the utility pole from corrosion; and (3) is electrically conductive to electrically ground the utility pole (e.g. to protect the utility pole from lightning strikes and powerline ground faults and prevent electrical fires).

As used herein, the term ‘cementitious product’ refers to a product that has a cementitious matrix—i.e. a matrix that is a cement (e.g. Portland cement), or consists essentially of a cement, or is made up largely of a cement (i.e. at least 20% by weight of the matrix is a cement). Various components, as described below, can be dispersed in (or otherwise mixed with) the cementitious matrix. The term ‘cementitious product’ can refer to a dry product (also referred to herein as a ‘cementitious powder’), a wet product (also referred to herein as a ‘cementitious slurry’), or a solid product (also referred to herein as a ‘cementitious surround’ or simply as a ‘surround’).

As used herein, the term ‘electrically-conductive’, when used with reference to the cementitious surround, indicates that the cementitious surround has an electrical resistivity of less than or equal to 10,000 ohm·cm. For example, the cementitious surround may have an electrical resistivity of less than 500 ohm·cm, or between 2.0 ohm·cm and 5.0 ohm·cm. When the cementitious surround is part of an assembly that includes a brace (e.g. an assembly that includes a gravel brace embedded in the surround), the assembly as a whole may have an electrical resistivity different from that of the surround alone.

As used herein, the term ‘water-impermeable’, when used with reference to the cementitious surround, indicates that the cementitious surround has a water permeability of less than or equal to 10⁻⁵ cm/s. For example, the cementitious surround may have a water permeability of 2.0×10⁻⁸ cm/s. When the cementitious surround is part of an assembly that includes a brace (e.g. an assembly that includes a gravel brace embedded in the cementitious surround), the assembly as a whole may have a water permeability different from that of the cementitious surround alone. For example, the assembly may have a water permeability of 4.34×10⁻⁷ cm/s or 2.5×10⁻⁵ cm/s.

As used herein, the term ‘in situ’ indicates that cementitious product is applied to the metallic structure at the installation location of the metallic structure. For example, the statement that ‘the cementitious product can be applied to the utility pole in situ’ indicates that the cementitious product can be applied to a bottom portion of the utility pole after a hole has been dug and the bottom end of the utility pole has been positioned in the hole (either as a new installation or as a retrofit).

The cementitious products disclosed herein generally include a particulate carbonaceous material (e.g. calcined petroleum coke) dispersed in the cementitious matrix (e.g. Portland cement). When cured, the cementitious matrix may provide the product with water impermeability, to protect the buried portion (or a section of the buried portion) of the metallic structure from corrosion, and the particulate carbonaceous material may provide the product with electrical conductivity, to electrically ground the metallic structure. For example, a cementitious powder can include a mixture of calcined petroleum coke, Portland cement, and optionally slag. In some examples, the cementitious powder can include a mixture of 50 wt % calcined petroleum coke and 50 wt % Portland cement. In other examples, the cementitious powder can include a mixture of between about 30 wt % and 90 wt % calcined petroleum coke, between about 5 wt % and 70 wt % Portland cement, and between about 1 wt % and 50 wt % slag. The cementitious product can optionally include additives, such as calcium chloride or other additives to provide quick setting properties, or water-reducing admixtures or superplasticizers.

In order to form the cementitious surround, the cementitious powder can be combined with water to form a slurry, which can then be applied in direct contact to the metallic structure in situ (e.g. poured into a hole that has been dug for a utility pole) and allowed to cure. In some examples, the cementitious powder can be combined with water in a ratio of less than or equal to about 3 US gallons of water per 55 lb of cementitious powder, for example between about 1.5 US gallons and 3.0 US gallons of water per 55 lb of cementitious powder. In one particular example, the cementitious powder can be combined with water in a ratio of about 2.0 US gallons of water per 55 lb of cementitious powder. This ratio may be particularly useful where the surround is formed on a utility pole. In another example, the cementitious powder can be combined with water in a ratio of about 2.5 US gallons of water per 55 lb of cementitious powder. This ratio may be particularly useful where the surround is formed on an anchor rod. Such cementitious slurries can be generally thick and have low slump. In other examples, particularly those in which an aggregate brace is used together with the cementitious product, as described below, the cementitious powder can be combined with water in a ratio of less than or equal to about 5 US gallons of water per 55 lb of cementitious powder, for example between about 2.5 US gallons and 5.0 US gallons of water per 55 lb of cementitious powder, more specifically between about 3.0 US gallons and 4.0 US gallons of water per 55 lb of cementitious powder. Such cementitious slurries can be generally thin and have high slump.

Alternatively, the initial step of combining with water can be omitted, and the cementitious powder can be applied in direct contact to the metallic structure in situ (e.g. poured into a hole that has been dug for a utility pole). Water can then be added to the cementitious powder in-situ, or the cementitious powder can be left and allowed to absorb environmental water (e.g. rainwater). The cementitious product can then be allowed to cure.

The cementitious products disclosed herein can in some examples have a generally low drying shrinkage, e.g. a drying shrinkage of less than or equal to about 0.20% after curing for 28 days, or a drying shrinkage of less than about 0.015% after curing for 28 days.

After curing, the cementitious surround can be relatively strong—i.e. can have a compressive strength of greater than or equal to about 50 psi (i.e. greater than about 0.34 MPa). For example, the compressive strength can be greater than 2000 psi (about 13.79 MPa), or about 4003 psi (about 27.6 MPa) or about 4350 psi (about 30 MPa), or about 914 psi (about 6.30 MPa), or about 624 psi (about 4.30 MPa), or about 348 psi (about 2.40 MPa), or about 174 psi (about 1.20 MPa), or about 65 psi (about 0.45 MPa) after curing (e.g. after 28 days of curing). Furthermore, in examples in which an aggregate brace such as gravel is embedded in the cementitious surround, as described below, the assembly of the cementitious surround and the gravel can have a compressive strength of greater than or equal to about 50 psi (i.e. greater than about 0.34 MPa). For example, the compressive strength can be about 1300 psi (8.96 MPa) or about 805 psi (5.55 MPa), after 28 days of curing.

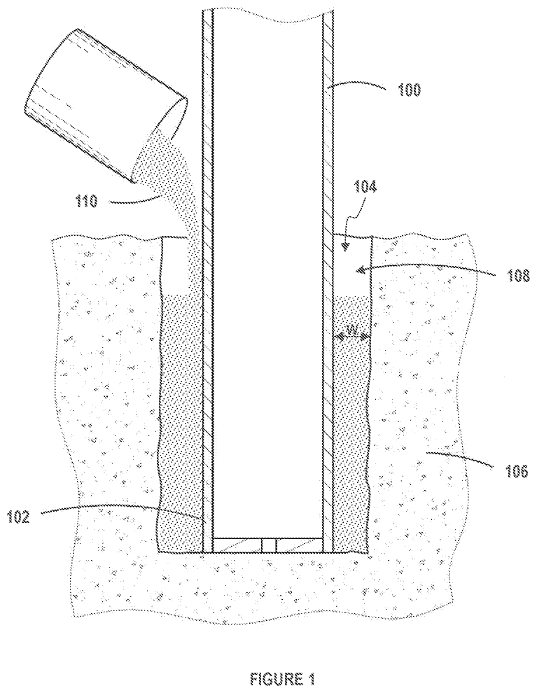

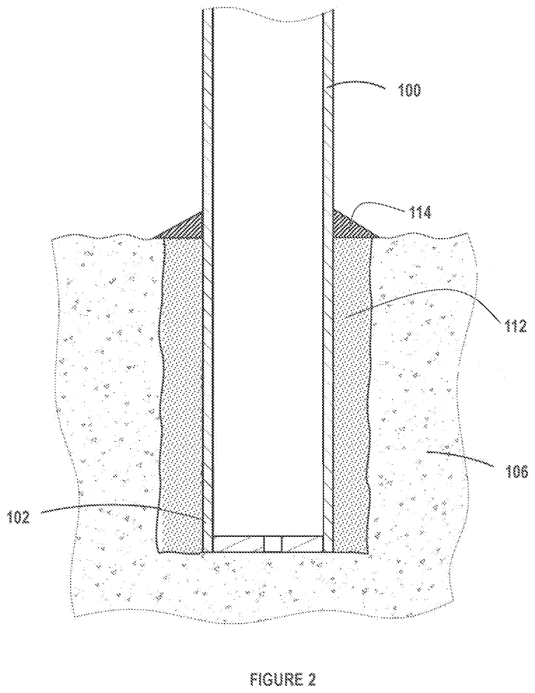

Referring now to FIG. 1, an assembly is shown that includes a metallic (e.g. steel) utility pole 100 in situ. A portion (i.e. the bottom portion 102) of the utility pole has been lowered into a hole 104 that has been dug in the earth 106 (e.g. dug into the earth 106 with an auger or a hydrovac or any other technique that involves removal of soil to create a hole). The hole 104 can be sized to have a diameter that is slightly larger than the utility pole 100, to leave a circumferential gap 108 between the utility pole 100 and the earth 106. The gap 108 can have a width W of, for example, between 0.5 inch and 10 inches, or between 1 inch and 6 inches. With the utility pole in this position, a cementitious slurry 110 as described above can be applied to the bottom portion 102 of the utility pole 100, for example by pouring the cementitious slurry into the gap 108 (although FIG. 1 shows the slurry 110 being poured from a pot, it may also be poured from a cement truck or other container). Alternatively, the cementitious slurry can first be applied to the hole, and the bottom portion of the utility pole can then be lowered into the hole and pressed into the slurry. If the bottom portion of the utility pole is closed as shown, this can cause the slurry to rise and fill the gap, or, if the bottom portion of the utility pole is open (not shown), the slurry can fill the bottom portion as well as the gap. A concrete vibrator can optionally be used to remove air trapped in the slurry. The slurry can then be left to cure, for example over a period of several days, to form the surround 112, as shown in FIG. 2. As mentioned above, the surround 112 is between the bottom portion 102 of the utility pole 100 and the earth 106 and can form a barrier between the bottom portion 102 of the utility pole 100 and the earth 106, is electrically conductive to allow the utility pole 100 to be electrically grounded, and is water impermeable to protect the utility pole 100 from corrosion.

As mentioned above, instead of applying a cementitious slurry to the utility pole 100, a cementitious powder can be applied to the utility pole 100 (e.g. by applying the cementitious powder to the gap 108). Water can then be added to the cementitious powder in-situ, or the cementitious powder can be left and allowed to absorb environmental water (e.g. rainwater). The cementitious product can then be allowed to cure.

Referring to FIG. 2, in order to prevent water (e.g. rainwater) from pooling around the utility pole 100, which can lead to corrosion, a diverter 114 can be installed or applied around the utility pole 100, on the top edge of the surround 112. The diverter 114 can be shaped to direct water away from the utility pole 100. The diverter 114 can be formed from a grout or polymeric material that is troweled around the utility pole 100. The diverter can optionally be or include an electrically conductive material.

A grounding grid can optionally be installed around the utility pole, for safety.

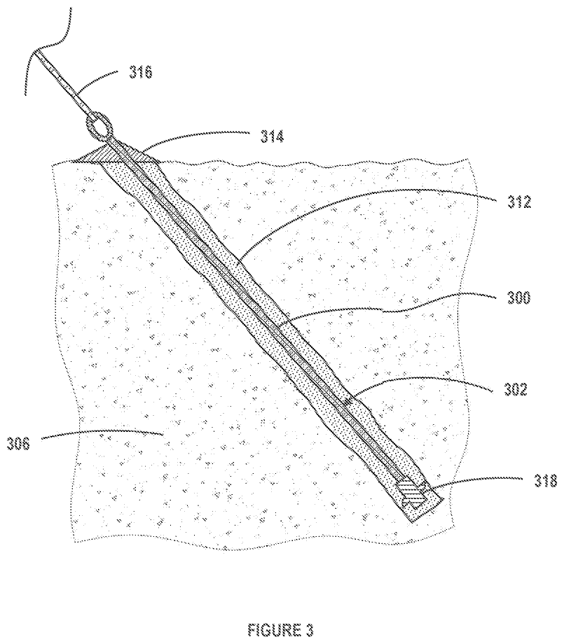

Referring to FIG. 3, another example is shown, in which the assembly includes a metallic structure in the form of an anchor rod 300 for a guy wire 316. The anchor rod 300 is shown in situ, with the anchor rod 300 lowered into a hole that has been dug in the earth 306. In the example shown, the entire anchor rod 300 is buried. In the example shown, the hole is an auger hole dug into the earth 306 with an auger; in alternative examples, the hole can be a trench dug into the earth with a backhoe. The hole has a diameter that is slightly larger than the anchor rod 300, to leave a circumferential gap (not shown) between the anchor rod 300 and the earth 306. A cementitious slurry as described above has been poured into the hole, to fill the gap between the anchor rod 300 and the earth 306, and the slurry has cured to form the surround 312. Alternatively, a cementitious powder can be poured into the hole, to fill the gap between the anchor rod and the earth. Water can then be added to the cementitious powder in-situ, or the cementitious powder can be left and allowed to absorb environmental water (e.g. rainwater). The cementitious product can then be allowed to cure.

In the example shown, an anchor 318 is mounted to the bottom portion 302 of the anchor rod 300, to secure the anchor rod 300 in the earth. In the example shown, the anchor 318 is fully embedded in the surround 312. In alternative examples, the anchor can be either fully or partially outside of the surround 312. The anchor can be of various configurations (e.g. a plate or a nut or another configuration).

In the example shown, the assembly of FIG. 3 further includes a diverter 314, similar to the diverter 114 of FIG. 2.

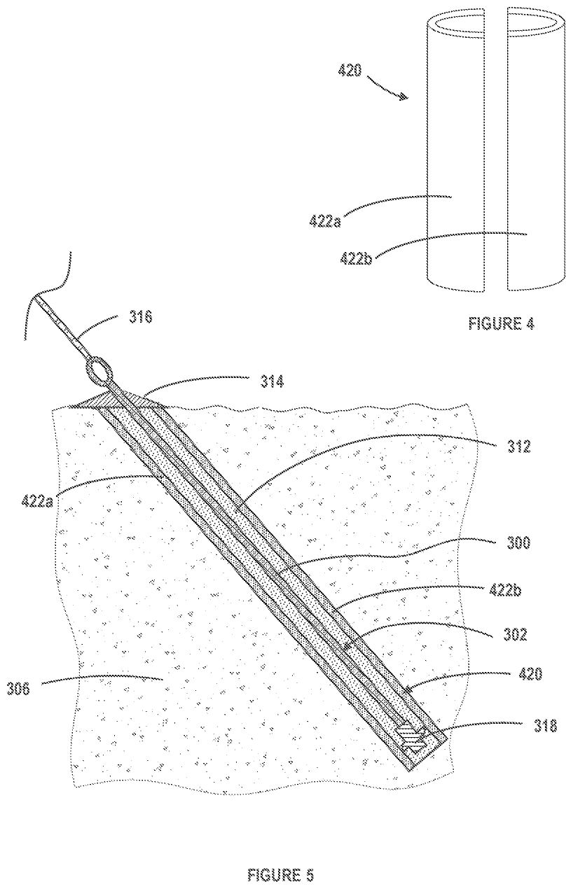

Referring now to FIGS. 4 and 5 (where features that are like those of FIG. 3 are referred to with the same reference numerals as in FIG. 3), in some examples, a jacket 420 can be used to encapsulate the surround 312. The jacket 420 can be electrically conductive and water impermeable. For example, the jacket can include a polymeric matrix, and a particulate carbonaceous material dispersed in the polymeric matrix. Such materials are described in U.S. Pat. No. 10,333,234 B2 (Sirola et al.), which is incorporated herein by reference in its entirety. In the example shown, the jacket 420 is in the form of a tube, which is formed in two pieces, 422a, 422b, which are positioned around the surround 312.

The jacket 420 can be used in various scenarios, but may be particularly useful in repair or retro-fit scenarios. For example, in situations where an anchor rod 300 is already installed in the earth 306, it may be required to dig up the earth 306 around the anchor rod 300 for various reasons, leaving the anchor rod 300 exposed (i.e. leaving the entire anchor rod exposed, or leaving only a section of the anchor rod exposed) and in a relatively large hole (not shown) that may be too large to fill with the cementitious product (i.e. having a diameter larger than the original auger hole that was created for the anchor rod 300). In such situations, the jacket 420 can be positioned in the hole around anchor rod 300 (i.e. either around the entire anchor rod 300, or around only the exposed section of the anchor rod 300) and secured in place (e.g. using a fastener such as a zip tie). The jacket 420 can then be filled with the cementitious material, e.g. by pouring a cementitious slurry as described above into the jacket 420, to fill the jacket 420 (or by pouring a cementitious powder into the jacket 420). The slurry can then cure to form the surround 312, and the hole can be filled with earth 306. In such examples, depending on how deep the hole around the anchor rod 312 has been dug, the surround 312 can be on the entire buried portion of the anchor rod 312, or on only a section of the buried portion of the anchor rod 312 (e.g. the top section).

In the example described above with reference to FIGS. 4 and 5, the jacket 420 encapsulates the surround 312. In alternative examples, the jacket can be a part of the metallic structure, and the surround can encapsulate the jacket. That is, the metallic structure can include a main structure and a jacket. The main structure can be, for example the metallic body of a utility pole. The jacket can be electrically conductive and water impermeable (e.g. can include a polymeric matrix such as an epoxy matrix, and a particulate carbonaceous material dispersed in the polymeric matrix), as described above, and can be applied directly to the bottom portion of the metallic body of the utility pole. The utility pole (including the metallic body and the jacket) can then be lowered into a hole that has been dug in the earth. A cementitious slurry as described above can then be poured into the gap that surrounds the utility pole.

Jackets as described above can also be used with structures other than anchor rods, e.g. poles.

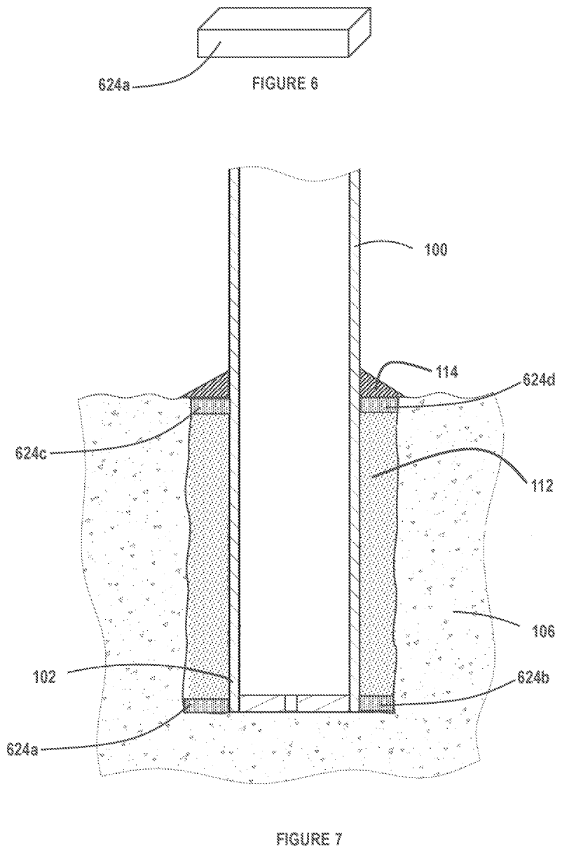

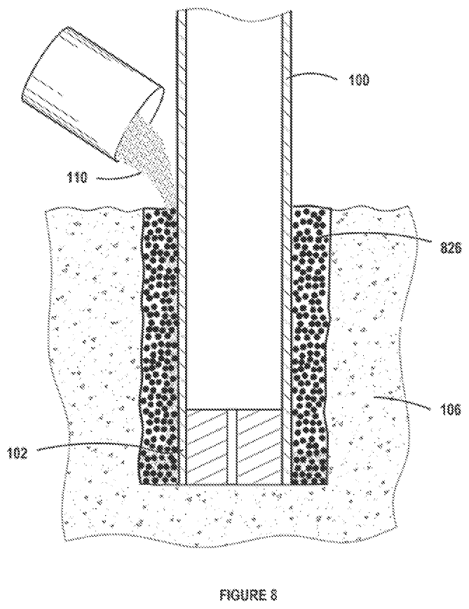

In some examples, the surround can be provided as part of an assembly that further includes one or more braces. For example, one or more braces can be embedded in the surround to further support the utility pole, particularly during the period while the cementitious product is in the process of curing. Referring now to FIGS. 6 and 7 (where features that are like those of FIGS. 1 and 2 are referred to with the same reference numerals as in FIGS. 1 and 2), in the example shown, braces 624a-d (only one of which is shown in FIG. 6) are embedded in the surround 112 to further support the utility pole 100, particularly during the period while the cementitious product is in the process of curing. The braces 624a-d can include a polymeric matrix, and a particulate carbonaceous material dispersed in the polymeric matrix. Such materials are described in U.S. Pat. No. 10,333,234 B2 (Sirola et al.), which is incorporated herein by reference in its entirety. The braces 624a-d can be in the form of elongate bars or rods or blocks (e.g. 4 inch×4 inch bars) that are cut to length to fit the gap between the utility pole 100 and the earth 106. To install the braces 624a-d, the bottom portion 102 of the utility pole 100 can be lowered into the hole 104 that has been dug in the earth 106 (e.g. dug into the earth 106 with an auger). The braces 624a-624d can then be positioned in the gap, around the utility pole 100, so that they are generally wedged between the utility pole 100 and the earth 106. The cementitious slurry as described above can then be applied to the utility pole, enveloping the braces 624a-624d. The slurry can then be left to cure, for example over a period of several days, to form the surround 112 with the braces 624a-624d embedded therein, as shown in FIG. 7.

In FIG. 7, four braces 624a-624d are shown (i.e. two lower braces 624a, 624b, and two upper braces 624c, 624d). However, another number of braces can be used, such as four lower braces and four upper braces.

In further examples, the brace can be in the form of an aggregate material, such as gravel. In such examples, the brace may be non electrically-conductive and non water-impermeable. For example, the brace can be or can include clear limestone gravel, crushed limestone gravel, pea gravel, and/or limestone screenings. In some examples, ¾″ clear limestone gravel may be preferred, as the cementitious product may readily flow therethrough to fill the space in the gravel. Referring to FIG. 8, to install a cementitious surround with gravel 826 as the brace, the bottom portion 102 of the utility pole 100 may be lowered into the hole that has been dug in the earth 106 (e.g. dug into the earth 106 with an auger). The gravel 826 can then be applied to the gap around the utility pole 100 to at least partially fill the gap. The gravel 826 can be compacted (e.g. tamped) to provide stability. Optionally, the gravel 826 can be applied in layers (e.g. layers of about 6 inches in depth), and each layer can be compacted before applying the next layer. The cementitious slurry 110 as described above can then be applied to the gravel 826 such that it flows through the gravel 826 and envelops the gravel 826. As mentioned above, in cases where gravel 826 is used as a brace, the cementitious slurry 110 may have a relatively high ratio of water to cementitious powder (e.g. up to 5 gallons of water per 55 lb of cementitious powder), to facilitate flow of the cementitious slurry 110 through the gravel 826. Optionally, there can be a delay between applying the gravel 826 and applying the cementitious slurry 110. For example, after applying the gravel 826, the gravel 826 and utility pole 100 may be left for a period of time (E.g. a delay of at least one day, such as several days or weeks). The cementitious slurry 110 may then be applied at a later date (optionally after adjusting—e.g. straightening—the utility pole 110). The slurry 110 can then be left to cure, for example over a period of several days, to form the surround with the gravel brace embedded therein.

Optionally, a ground rod may be used in conjunction with the surround. For example, a ground rod may be driven into the earth 106 proximate the utility pole 100 and connected to the power system neutral. Alternatively, where a gravel brace is used, the ground rod may be placed in the hole and surrounded by the gravel.

As mentioned above, the metallic structures described herein can include metallic parts of ancillary structures (e.g. metal claddings on non-metallic structures such as wood poles). In one particular example (not shown), the ancillary structure can be a wood pole (e.g. utility pole), and the metallic structure can be a cladding on the bottom portion of the wood pole. The cladding can be, for example, a material such as a foil. The foil can be, for example, a copper foil or steel (e.g. galvanized steel) foil that is wrapped around the bottom portion of the wood pole. A wire can connect the cladding to a power system neutral of the utility pole. The bottom portion of the wood pole, together with the cladding, can be lowered into a hole that has been dug in the earth and a cementitious product (i.e. a slurry or a powder) can then be applied to the cladding and allowed to cure to form a surround, as described above.

While the above description refers to portions of the metallic structures (e.g. bottom portions) being buried in the earth and the surround being on such buried portions, it is possible that the entire metallic structure may be buried in the earth, and the surround may be on the entire metallic structure. For example, in the case of a metallic cladding on a wood pole, the entire cladding may be buried in the earth and the surround may surround the entire cladding. For further example, in the case of an anchor rod, the entire anchor rod may be buried in the earth and the surround may surround the entire anchor rod. Furthermore, the surround may in some examples be applied to only a section of the buried portion of the metallic structure. For example, in the case of repair to an anchor rod, the surround may be applied to only the section of the anchor rod that is exposed when a trench is dug (e.g. the top 3 to 4 feet of the anchor rod).

While the above description provides examples of one or more processes or apparatuses or compositions, it will be appreciated that other processes or apparatuses or compositions may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

### EXAMPLES

### Example 1—Material Properties of Cementitious Products

Preparation of Cementitious Powders: Various cementitious powders were made, as shown in Tables 1 to 3. The powders were prepared by blending the components in a pneumatic blender. The powders were stored in 55 lb bags.

TABLE 1
Composition of Cementitious Powder 1

| Component | Weight % |
|---|---|
| Particulate carbonaceous material: | 50.0 |
| CC60 Calcined Petroleum Coke (Oxbow | |
| Calcining LLC) | |
| Portland Cement | 50.0 |
| (Contempra Type GUL Portland | |
| Limestone Cement, St Mary's Cement) | |

TABLE 2
Composition of Cementitious Powder 2

| Component | Weight % |
|---|---|
| Particulate carbonaceous material: | 70.0 |
| CC60 Calcined Petroleum Coke (Oxbow | |
| Calcining LLC) | |
| Portland Cement | 30.0 |
| (Contempra Type GUL Portland | |
| Limestone Cement, St Mary's Cement) | |

TABLE 3
Composition of Cementitious Powder 3

| Component | Weight % |
|---|---|
| Particulate carbonaceous material: | 80.0 |
| CC60 Calcined Petroleum Coke (Oxbow | |
| Calcining LLC) | |
| Portland Cement | 20.0 |
| (Contempra Type GUL Portland | |
| Limestone Cement, St Mary's Cement) | |

Electrical Resistivity Testing of Cementitious Powders: Cementitious Powders 1 to 3 were tested for electrical resistivity following a modified ASTM G187-05 procedure: Standard Test Method for Measurement of Soil Resistivity using the Two Electrode Soil Box Method. Cementitious powder (10 g) was placed in a fixture in between 2 brass platens. An Instron was used to apply a force of 192 lbs/int to the fixture, and the resistivity of the sample (measured between the 2 brass platens) was measured using a rectifier. Results are shown in Tables 4 to 6.

Electrical Resistivity Testing of Assemblies of Aggregate Brace Embedded in A Cementitious Surround: Assemblies of an aggregate brace embedded in a cementitious surround were built by augering two holes 24 inches in diameter by 4 feet deep in soil of known resistivity. A 4 inch diameter galvanized steel fence post was placed in the centre of each hole and the space around the fence post was filled with ¾″ clear gravel. The measured electrical resistance of the galvanized steel fence post in ¾″ clear gravel was >1500 ohms and the calculated electrical resistivity was >34,910 ohm-cm. Cementitious Powder 1 was mixed with water at two different water ratios to yield cementitious slurries. Mixing was conducted using a cement mixer until the slurry reached a smooth consistency. Each slurry was poured into one of the augered holes through the ¾″ clear gravel to form the assembly and then allowed to cure for 28 days at ambient temperature and humidity conditions. The measured electrical resistance of the assembly made with the 3 US gallon water ratio was 41 ohms and the calculated electrical resistivity was 960 ohm-cm. The measured electrical resistance of the assembly made with the 4 US gallon water ratio was 21 ohms and the calculated electrical resistivity was 500 ohm-cm.

Testing of Cementitious Surround: Cementitious Powders 1 to 3 were mixed with water (at various ratios set out below) to yield a cementitious slurry. Mixing was conducted using a drill with a grout mixing paddle until the slurry reached a smooth consistency. The slurry was then cured (as described below), and the cured product was tested for material properties, including water permeability, shrinkage, and compressive strength. Results are shown in Tables 4 to 6.

Testing of Assemblies of An Aggregate Brace Embedded in A Cementitious Surround: Cementitious Powder 1 was mixed with water (at the various ratios set out below) to yield a cementitious slurry. Mixing was conducted using a drill with a grout mixing paddle until the slurry reached a smooth consistency. The slurry was poured into 4 inch×8 inch PVC cylinders filled with ¾″ clear gravel to form the assembly and then cured (as described below). The cured assembly was tested for material properties, including water permeability and compressive strength. Results are shown in Table 7.

Water Permeability Testing of Cementitious Surround: Cementitious Powders 1 to 3 were mixed with water at a ratio of 55 lb of cementitious powder to 3 US gallons of water. The cementitious slurry was then poured into 4 inch×8 inch PVC cylinders in 2 even layers. Each layer was rodded to remove entrained air. Lids were sealed on the cylinders and the material was allowed to cure for 28 days in the cylinder (ambient temperature and humidity conditions) before being demoulded and tested for water permeability. Water permeability tests followed ASTM D5084: Hydraulic Conductivity of Saturated Porous Materials using a Flexible Wall Permeameter—Constant Volume. The demoulded samples were placed into the permeameter and subjected to an effective stress of 2.6 psi, and the permeability rate of water through the material was calculated. Results are shown in Tables 4 to 6.

Water Permeability Testing of Assemblies of An Aggregate Brace Embedded in A Cementitious Surround: Two different water ratios were tested—55 lbs of Cementitious Powder 1 was combined with 3 US gallons of water for the first water ratio and 55 lbs of Cementitious Powder 1 was combined with 4 US gallons of water for the second water ratio. 4 inch×8 inch PVC cylinders were filled with ¾″ clear gravel. The cementitious slurry for each water ratio was poured into the PVC cylinders through the gravel and tapped to remove entrained air. Lids were sealed on the cylinders and the assemblies were allowed to cure for 28 days in the cylinder (ambient temperature and humidity conditions) before being demoulded and tested for water permeability. Water permeability tests followed ASTM D5084: Hydraulic Conductivity of Saturated Porous Materials using a Flexible Wall Permeameter—Constant Volume. The demoulded samples were placed into the permeameter and subjected to an effective stress of 2.6 psi, and the permeability rate of water through the assembly was calculated. Results are shown in Table 7.

Shrinkage Tests of Cementitious Surround: For shrinkage tests, 55 lb of Cementitious Powders 1 to 3 was combined with 3 US gallons of water. Shrinkage tests followed ASTM C157: Length Change of Hardened Hydraulic-Cement Mortar and Concrete. The cementitious slurry was cast into prisms for linear shrinkage testing. Prism specimens were wet cured in lime saturated water for 28 days, followed by 28 days of air storage in a humidity and temperature controlled drying room. Shrinkage was measured after demoulding, after 28 days of wet curing, and after 4, 7, 14 and 28 days of air storage. Results (shown in Tables 4 to 6) show the shrinkage after 28 days of air storage.

Compressive Strength Test of Cementitious Surround: For compressive strength tests, up to three water ratios were tested with each of Cementitious Powders 1 to 3: 55 lb of cementitious powder 1 combined with 1.8 US gallons of water, 55 lb of cementitious powder 1 combined with 2.5 US gallons of water, and 55 lb of each of cementitious powders 1, 2, and 3 combined with 3.0 US gallons of water. Each cementitious slurry was poured into 4 inch×8 inch PVC cylinders in 2 even layers. Each layer was rodded to remove entrained air. Lids were sealed on the cylinders and the material was allowed to cure for 28 days in the cylinder (ambient temperature and humidity conditions) before being demoulded and tested for compressive strength. Compressive strength tests followed CAN/CSA A.23.2-14. After demoulding the samples were placed in between 2 plates. Force was applied until the material fractured. The amount of force required to fracture the material is the recorded compressive strength. Results are shown in Tables 4 to 6.

Compressive Strength Test of Assemblies of An Aggregate Brace Embedded in A Cementitious Surround: Two different water ratios were tested: 55 lbs of Cementitious Powder 1 combined with 3 US gallons of water and 55 lbs of cementitious powder combined with 4.0 US gallons of water. Each cementitious slurry was poured into 4 inch×8 inch PVC cylinders filled with ¾″ clear gravel. The containers were trapped to remove entrained air. Lids were sealed on the cylinders and the assemblies were allowed to cure for 28 days in the cylinder (ambient temperature and humidity conditions) before being demoulded and tested for compressive strength. Compressive strength tests followed CAN/CSA A.23.2-14. After demoulding the samples were placed in between 2 plates. Force was applied until the assembly fractured. The amount of force required to fracture the material is the recorded compressive strength. Results are shown in Table 7.

TABLE 4
Properties of Cementitious Product 1

| Property | Value (average) | |
|---|---|---|
| Permeability to Water (n = 2) | 2.0 × 10⁻⁸ | cm/sec |
| Shrinkage (n = 3) | 0.015% | |
| Electrical Resistivity (n = 5) | 2.8-5.0 | Ω · cm |
| Compressive Strength | | |

| | |
|---|---|
| 1.8 US gallons of water/bag (n = 2) | 7005 psi (48.3 MPa) |
| 2.5 US gallons of water/bag (n = 2) | 4569 psi (34.5 MPa) |
| 3.0 US gallons of water/bag (n = 2) | 4003 psi (27.6 MPa) |

TABLE 5
Properties of Cementitious Product 2

| Property | Value (average) | |
|---|---|---|
| Permeability to Water (n = 4) | 1.85 × 10⁻⁷ | cm/sec |
| Electrical Resistivity (n =8) | 0.5-2.0 | Ω · cm |
| Compressive Strength | | |

| | |
|---|---|
| 3.0 US gallons of water/bag (n = 2) | 914 psi (6.30 MPa) |

TABLE 6
Properties of Cementitious Product 3

| Property | Value (average) | |
|---|---|---|
| Permeability to Water (n = 4) | 1.46 × 10⁻⁶ | cm/sec |
| Electrical Resistivity (n = 6) | 0.4-3.0 | Ω · cm |
| Compressive Strength | | |

| | |
|---|---|
| 3.0 US gallons of water/bag (n = 2) | 348 psi (2.40 MPa) |

TABLE 7
Properties of Assembly (¾″ clear
gravel brace embedded in Cementitious Surround)

| Property | Value (average) | |
|---|---|---|
| Electrical Resistance | | |
| 3 US Gallons Water Ratio (n = 1) | 41 | ohms |
| 4 US Gallons Water Ratio (n = 1) | 21 | ohms |
| Electrical Resistivity | | |
| 3 US Gallons Water Ratio (n = 1) | 960 | ohm · cm |
| 4 US Gallons Water Ratio (n = 1) | 500 | ohm · cm |
| Permeability to Water | | |
| 3 US Gallons Water Ratio (n = 2) | 4.37 × 10⁻⁷ | cm/sec |
| 4 US Gallons Water Ratio (n = 2) | 2.5 × 10⁻⁵ | cm/sec |
| Compressive Strength | | |

| | |
|---|---|
| 3.0 US Gallons Water Ratio (n = 2) | 1300 psi (8.96 MPa) |
| 4 US Gallons Water Ratio (n = 2) | 805 psi (5.55 MPa) |

### Example 2—Corrosion Protection of Metallic Structures by Cementitious Surrounds

Cementitious products were tested for their ability to protect copper, steel, and galvanized steel structures from corrosion.

Copper:

Copper samples (¾ inch×3 inch rectangular strips having a thickness of 0.2 mm (0.008 inch)) were connected to insulated wire, which was then connected to a rectifier. One strip was left bare and the second strip was encased in a 4 inch×8 inch cementitious surround.

The cementitious surround was made using a cementitious powder of the composition shown in Table 1. A cementitious slurry was made by adding 55 lbs of the cementitious powder to 3.3 US gallons of water and mixing, as described above. The copper samples were embedded in the slurry in a 4 inch×8 inch PVC cylinder as described above, and the slurry was allowed to cure for 13 days (ambient temperature and humidity conditions) before demoulding.

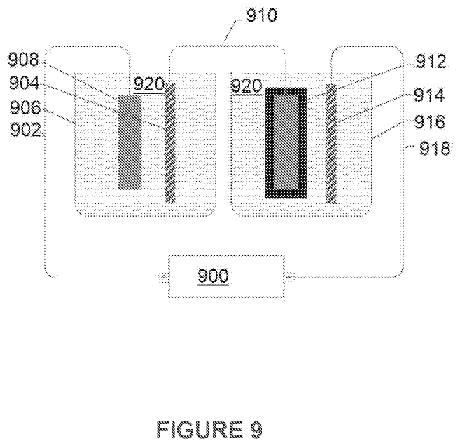

Both samples (i.e. bare strip and encased strip) were buried in topsoil. Sodium sulfate (20 g) was added to the soil and water was regularly added to ensure the soil was wet and salty (to simulate worst case conditions). Samples were connected to the rectifier in series, and 3 mA was applied to each sample for 60 days. The experimental setup is shown in FIG. 9. In FIG. 9, the following reference numerals are used: 900—regulated power supply; 902—insulated positive wire; 904—test container; 906—steel rebar (cathodic); 908—bare metal (anodic); 910—insulated bond wire; 912—metal encased in cementitious surround (anodic); 914—steel rebar (cathodic); 916—test container; 918—insulated negative wire; 920—soil.

The samples were then removed from the soil. The encased strip was removed from the cementitious surround. Both copper strips were then weighed. Results are shown in Table 8.

Steel:

Steel samples (1.75 inch×¾ inch rectangular sections having a thickness of ¼ inch) were connected to insulated wire, which was then connected to a rectifier. One section was left bare and the second section was encased in a 4 inch×8 inch cementitious surround. The cementitious surround was made as described above for copper; however the slurry was cured for 28 days.

Both samples (i.e. bare section and encased section) were buried in topsoil. Sodium sulfate (20 g) was added to the soil and water was regularly added to ensure the soil was wet and salty. Samples were connected to the rectifier in series, and 3 mA was applied to each sample for 30 days. The experimental setup was the same as shown in FIG. 9.

The samples were then removed from the soil. The encased section was removed from the cementitious surround. Both steel sections were then weighed. Results are shown in Table 8.

Galvanized Steel:

Galvanized Steel in Cementitious Surround: Galvanized steel samples were 1.75 inch×¾ inch rectangular sections having a thickness of ¼ inch. Galvanizing met ASTM A123/A123M, and the samples had a zinc coating of at least 0.025 mm (0.001 inch). The sections were connected to insulated wire, which was then connected to the rectifier. One section was left bare and the second section was encased in a 4 inch×8 inch cementitious surround. The cementitious surround was made as described above for steel. The experiment was conducted as described above for steel. Results are shown in Tables 8.

Galvanized Steel in Assembly of Aggregate Brace Embedded in Cementitious Surround: Galvanized steel samples were 1.75 inch×¾ inch rectangular sections having a thickness of ¼ inch. Galvanizing met ASTM A123/A123M, and the samples had a zinc coating of at least 0.025 mm (0.001 inch). The sections were connected to insulated wire, which was then connected to the rectifier. One section was encased in a brace consisting of ¾″ clear gravel and the second section was encased in a brace consisting of ¾″ clear gravel then a cementitious slurry was poured into the gravel so that it enveloped the brace and galvanized steel to form an assembly. The cementitious slurry was prepared by mixing Cementitious Powder 1 with water at a ratio of 3 US gallons of water per 55 lbs of cementitious powder. Mixing was conducted using a drill with a grout mixing paddle until the slurry reached a smooth consistency. The assembly was allowed to cure for 28 days at ambient temperature and humidity. Both samples were buried in topsoil. Water was regularly added to ensure the soil was wet. Samples were connected to the rectifier in series, and 3 mA was applied to each sample for 180 days. The samples were then removed from the soil and the sample enveloped in the assembly was removed from the gravel brace and cementitious surround. Both galvanized steel sections were then weighed. Results are shown in Table 9. The experimental setup is shown in FIG. 9.

The results indicate that the cementitious products disclosed herein can inhibit or prevent corrosion of metal including copper, steel, and galvanized steel.

TABLE 8
Electrical Corrosion Resistance of Various Metals

| | Percentage of Sample |
|---|---|
| | Consumed after 30 days |
| Sample | or 60 days (%) |
| Copper without Cementitious Surround | 94.80 |
| (in direct contact with soil) | |
| Copper Encased in Cementitious Surround | 0.00 |
| Steel without Cementitious Surround | 5.79 |
| (in direct contact with soil) | |
| Steel Encased in Cementitious Surround | 0.00 |
| Galvanized Steel without Cementitious | 7.70 |
| Surround (in direct contact with soil) | |
| Galvanized steel Encased in Cementitious | 0.00 |
| Surround | |

TABLE 9
Electrical Corrosion Resistance of Various Metals

| | Percentage of |
|---|---|
| | Sample Consumed |
| Sample | after 180 days (%) |
| Galvanized Steel Encased in a brace of ¾″ clear | 18.36 |
| gravel (in direct contact with soil) | |
| Galvanized steel Encased in a Cementitious | 4.95 |
| Surround with ¾″ clear gravel enveloped in the | |
| surround as a brace | |

We claim:

1. An electrically grounded and corrosion-protected assembly, comprising:
a metallic structure having a bottom portion that is buried in the earth;
a water impermeable and electrically conductive cementitious surround applied to at least a section of the portion that is buried in the earth, wherein the surround is in direct contact with the section and is between the section and the earth; and
a brace embedded in the surround and supporting the metallic structure.

2. The electrically grounded and corrosion-protected assembly of claim 1, wherein the metallic structure is a utility pole.

3. The electrically grounded and corrosion-protected assembly of claim 2, wherein the utility pole comprises a metallic body and an electrically conductive and water impermeable jacket applied to the metallic body.

4. The electrically grounded and corrosion-protected assembly of claim 1, wherein the brace is non electrically conductive and non water impermeable.

5. The electrically grounded and corrosion-protected assembly of claim 1, wherein the brace comprises an aggregate.

6. The electrically grounded and corrosion-protected assembly of claim 1, wherein the brace comprises a gravel.

7. The electrically grounded and corrosion-protected assembly of claim 1, wherein the cementitious surround comprises a cementitious matrix and a particulate carbonaceous material dispersed in the cementitious matrix.

8. The electrically grounded and corrosion-protected assembly of claim 7, wherein the cementitious matrix comprises Portland cement.

9. The electrically grounded and corrosion-protected assembly of claim 7, wherein the particulate carbonaceous material comprises calcined petroleum coke.

10. The electrically grounded and corrosion-protected assembly of claim 1, wherein the cementitious surround comprises between 5 wt % and 70 wt % Portland cement, and between 30 wt % and 90 wt % calcined petroleum coke.

11. The electrically grounded and corrosion-protected assembly of claim 10, wherein the cementitious surround comprises up to 50% slag.

12. A method for electrically grounding and corrosion-protecting a metallic structure, comprising:
a. positioning a brace in a gap around a bottom portion of a metallic structure that has been lowered into a hole in the earth, wherein the gap is between the bottom portion and the earth, and wherein the brace is positioned around the metallic structure to support the metallic structure;
b. enveloping the brace in a cementitious slurry, wherein the cementitious slurry comprises a cementitious matrix and a particulate carbonaceous material dispersed in the matrix; and
c. curing the cementitious slurry with the brace embedded therein, to form a water impermeable and electrically conductive cementitious surround on the section.

13. The method of claim 12, wherein step a. comprises at least partially filling the gap with an aggregate, to form the brace.

14. The method of claim 13, wherein the aggregate comprises a gravel.

15. The method of claim 14, wherein step a. further comprises compacting the gravel.

16. The method of claim 12, wherein the method further comprises combining a cementitious powder with water to form the cementitious slurry, wherein the cementitious powder is combined with the water in a ratio of less than or equal to about 5 US gallons of water per 55 lb of cementitious powder.

17. The method of claim 16, wherein the cementitious powder is combined with the water in a ratio of between about 3.0 and about 4.0 US gallons of water per 55 lb of cementitious powder.

18. The method of claim 16, wherein the cementitious powder comprises between 5 wt % and 70 wt % Portland cement, and between 30 wt % and 90 wt % calcined petroleum coke.

19. The method of claim 12, wherein there is a delay of at least one day between steps a. and b.

20. The method of claim 12, further comprising adjusting the metallic structure between steps a. and b.

21. An assembly for supporting a metallic structure, protecting the metallic structure from corrosion, and electrically grounding the metallic structure, comprising:
a water impermeable and electrically conductive cementitious surround comprising a cementitious matrix and a particulate carbonaceous material dispersed in the cementitious matrix, wherein the surround provides corrosion protection and electrical grounding; and
a brace embedded in the surround, wherein the brace provides support.

22. The assembly of claim 21, wherein the brace comprises an aggregate.
